(19) United States
(12) Patent Application Publication
(10) Pub. No.: US 2017/0129378 A1
(43) Pub. Date: May 11, 2017

(54) Animal Ramp and Method

(71) Applicant: Unlimited Creations, LLC, Aiken, SC (US)

(72) Inventor: Craig A. Kaplenski, Aiken, SC (US)

(73) Assignee: Unlimited Creations, LLC, Aiken, SC (US)

(21) Appl. No.: 14/935,028

(22) Filed: Nov. 6, 2015

(51) Int. Cl. B60P 1/43

(52) U.S. Cl. CPC B60P 1/43

(57) ABSTRACT

According to one embodiment, a ramp for loading an animal carcass into a vehicle includes a ramp body having a top surface, a bottom surface, a first end, a second end, a first side, and a second side. The ramp body is curved, and the first end is separated from the second end by a length. The ramp body is designed to be positioned at a sloping angle between a portion of the vehicle and a ground surface so as to allow the animal carcass to be slid upward along the top surface of the ramp body into the vehicle. The ramp further includes a first flange and a second flange coupled to the bottom surface of the ramp body. The first flange is designed to be positioned against the portion of the vehicle, and the second flange is designed to be positioned against the ground surface.

### TECHNICAL FIELD

This disclosure relates generally to the field of ramps and more specifically to an animal ramp and method.

### BACKGROUND

Traditionally, a person has loaded an animal carcass into their vehicle by physically lifting the entire animal carcass off of the ground and placing it into the vehicle, such as into the bed of a truck. Other traditional methods of loading an animal carcass may utilize a wooden board and a winch to pull the animal carcass up the wooden board and into the vehicle. Such traditional methods, however, may be deficient.

### SUMMARY

According to one embodiment, a ramp for loading an animal carcass into a vehicle includes a ramp body having a top surface, a bottom surface, a first end, a second end, a first side, and a second side. The ramp body is curved, and the first end of the ramp body is separated from the second end of the ramp body by a length of the ramp body. The ramp body is designed to be positioned at a sloping angle between a portion of the vehicle and a ground surface so as to allow the animal carcass to be slid upward along the top surface of the ramp body into the vehicle. The ramp further includes a first flange and a second flange coupled to the bottom surface of the ramp body. The first flange is designed to be positioned against the portion of the vehicle, and the second flange is designed to be positioned against the ground surface.

Certain embodiments of the disclosure may provide one or more technical advantages. For example, the ramp body may be curved. As such, the animal carcass may be slid (or otherwise moved) up the ramp body from the ground surface to the vehicle without the risk (or with less risk) of the animal carcass falling off the sides of the ramp body. As another example, a second flange may be coupled to the ramp body and may be designed to be positioned against the ground. As such, the second flange may provide stabilization of the ramp body on the ground surface, which may prevent (or reduce the risk of) the shape of the ramp body (such as the curve of the ramp body, for example) from causing the ramp body to tilt from side to side as the animal carcass is slid (or otherwise moved) up the ramp body into the vehicle.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIG. 1 illustrates an example ramp positioned between a vehicle and a ground surface;

FIGS. 2A-2C illustrate various views of an example of the ramp of FIG. 1;

FIGS. 3A-3F illustrate front views of other examples of the ramp of FIG. 1;

FIGS. 4A-4E illustrate various views of another example of the ramp of FIG. 1; and

FIG. 5 illustrates an example method of using a ramp.

### DETAILED DESCRIPTION

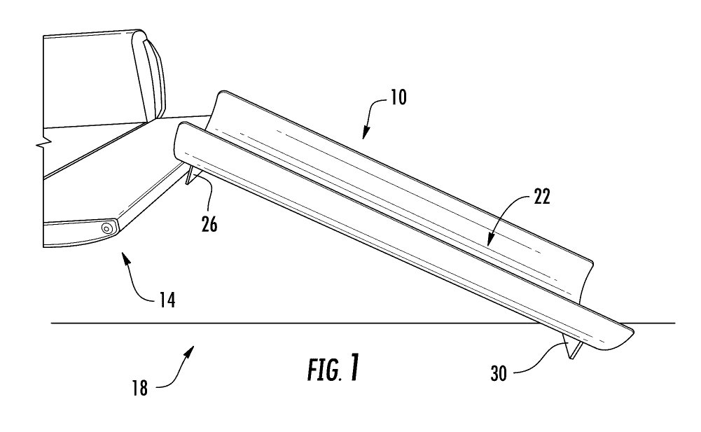

Embodiments of the present disclosure are best understood by referring to FIGS. 1-5 of the drawings, like numerals being used for like and corresponding parts of the various drawings.

Traditionally, a person has loaded an animal carcass into their vehicle by physically lifting the entire animal carcass off of the ground and placing it into the vehicle, such as into the bed of a truck. Other traditional methods of loading an animal carcass may utilize a wooden board and a winch to pull the animal carcass up the wooden board and into the vehicle. Such traditional methods, however, may be deficient. For example, it may be burdensome to physically lift the entire animal carcass off of the ground and place it into the vehicle. In particular, a deer may weigh, for example, 660 pounds, which may require 3-4 people to physically lift the deer carcass off of the ground. This may put the people at risk of straining their backs, and may not even be possible if the person is hunting alone and has nobody to help him lift the animal carcass. As another example, even when a wooden board and a winch are utilized, the process may be difficult because the traditional wooden board is entirely flat. As such, even when the animal carcass can be slid up the wooden board, the movement of the animal carcass (along with the weight of the animal carcass) may cause it to slide to the left or right of the wooden board, which could cause the animal carcass to fall off the wooden board. In such a case, the animal carcass could hurt a person or cause damage to the vehicle. Furthermore, the entire process may need to be restarted in order for the animal carcass to be loaded into the vehicle. Contrary to such typical deficiencies, the ramp 10 of FIGS. 1-4 may provide one or more advantages, as is discussed below.

FIG. 1 illustrates an example ramp 10 positioned between a vehicle 14 and a ground surface 18. As illustrated, the ramp 10 includes a ramp body 22, a first flange 26, and a second flange 30. The ramp body 22 may be shaped to prevent an animal carcass (such as a deer carcass) from falling off the sides of the ramp body 22. For example, the ramp body 22 may be curved, as is illustrated in FIG. 1. As such, the animal carcass may be slid (or otherwise moved) up the ramp body 22 from the ground surface 18 to the vehicle 14 without the risk (or with less risk) of the animal carcass falling off the sides of the ramp body 22. Furthermore, the second flange 30 may prevent the ramp body 22 from tilting from side to side. For example, the second flange 30 may extend downward from the curve of the ramp body 22, and may further include a flat bottom. As such, the second flange 30 may provide stabilization of the ramp body 22 on the ground surface 18, which may prevent (or reduce the risk of) the curve of the ramp body 22 from causing the ramp body 22 to tilt from side to side as the animal carcass is slid (or otherwise moved) up the ramp body 22 into the vehicle 14.

The ramp 10 may be used to load an animal carcass into the vehicle 14 (and/or unload the animal carcass from the vehicle 14). An animal carcass may refer to the body of a dead animal. The animal carcass may be the body of any dead animal. For example, the animal carcass may be a deer carcass, a hog carcass, a boar carcass, an elk carcass, a moose carcass, a bear carcass, a wolf carcass, a tiger carcass, or the carcass of any other animal. Furthermore, although the ramp 10 is described herein as being used to load an animal carcass into the vehicle 14 (and/or unload an animal carcass from the vehicle 14), the ramp 10 may be used to load any other item into the vehicle 14 (and/or unload any other item from the vehicle). For example, the ramp 10 may be used to load (and/or unload) sand bags, building materials, machinery, any other item, or any combination of the preceding.

The ramp 10 may include the ramp body 22. The ramp body 22 may be positioned between the vehicle 14 and the ground surface 18. The vehicle 14 may be any device that may be used to transport people and/or goods (such as an animal carcass). For example, the vehicle 14 may be a car, a truck, an airplane, a boat, a cart, a wheelbarrow, any other device that may be used to transport people and/or goods, or any combination of the preceding. As illustrated, the vehicle 14 is a truck, and the animal carcass may be loaded into the bed of the truck. The ground surface 18 may be any type of surface. For example, the ground surface 18 may be soil, dirt, mud, grass, sand, gravel, rock, vegetation, wetlands, any other naturally occurring type of surface, concrete, cement, any other type of artificial surface, or any combination of the preceding. The ground surface 18 may be flat, sloped downhill or uphill (e.g., a hill or mountain), irregular, or any combination of the preceding.

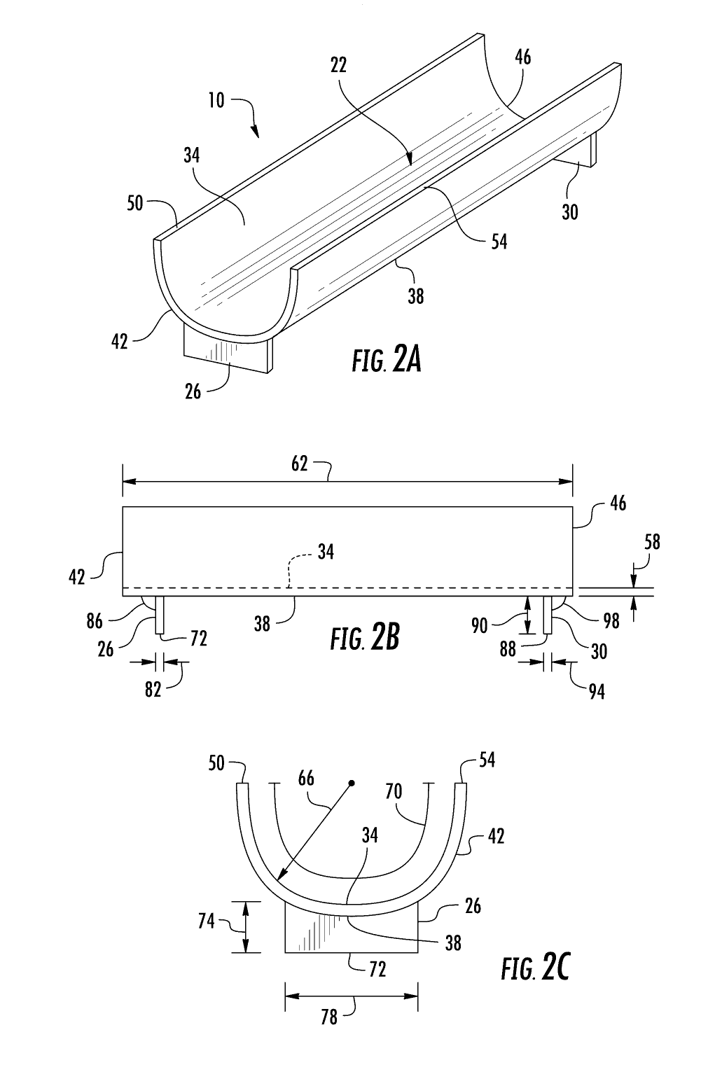

The ramp body 22 may be positioned in any way between the vehicle 14 and the ground surface 18 in order to load (and/or unload) the animal carcass. For example, the ramp body 22 may be positioned at a sloping angle between a portion of the vehicle 14 (such as the back of a bed of a truck, or the tailgate of a bed of a truck) and the ground surface 18. In such an example, the animal carcass may be slid (or otherwise) moved upward along the ramp body 22 and into the vehicle 14. The sloping angle may be any angle that creates a slope between the portion of the vehicle 14 and the ground surface 18. For example, the sloping angle may be any angle less than 90 degrees and greater than zero degrees, such as 60 degrees, 45 degrees, 40 degrees, 35 degrees, 30 degrees, or 25 degrees. In particular embodiments, the degree of the sloping angle may be based on a length of the ramp body 22, the height of the vehicle 14, the height of the portion of the vehicle 14, and/or the position of the ground surface 18 (e.g., flat, inclined, irregular). Additional details regarding examples of the ramp body 22 of the ramp 10 are discussed below with regard to FIGS. 2-4.

The ramp 10 may further include the first flange 26. The first flange 26 may be positioned against a portion of the vehicle 14, such as the back of the bed of a truck or the tailgate of a bed of a truck. Furthermore, the first flange 26 may further prevent the ramp body 22 from moving further into the vehicle 14. For example, the first flange 26 may extend downward from the ramp body 22, thereby creating a ledge (or a stop) that may prevent the ramp body 22 from moving further into the vehicle (e.g., moving towards the left in FIG. 1) while the animal carcass is slid along the ramp body 22. Instead, the first flange 26 may hold the ramp body 22 in place against the portion of the vehicle 14. Additional details regarding examples of the first flange 26 of the ramp 10 are discussed below with regard to FIGS. 2-4.

The ramp 10 may further include the second flange 30. The second flange 30 may be positioned against the ground surface 18. For example, the second flange 30 may be in contact with the top of the ground surface 18 or inserted (at least partially) into the ground surface 18. Furthermore, the second flange 30 may further prevent the ramp body 22 from tilting from side to side. For example, the second flange 30 may extend downward from the ramp body 22. As such, the second flange 30 may provide stabilization of the ramp body 22 on (or in) the ground surface 18, which may prevent (or reduce the risk of) the shape of the ramp body 22 from causing the ramp body 22 to tilt from side to side as the animal carcass is slid (or otherwise moved) up the ramp body 22 into the vehicle 14. Additionally, the second flange 30 may further prevent the ramp body 22 from moving further away from the vehicle 14. For example, the second flange 30 may extend downward from the ramp body 22 and may be in contact with the top of the ground surface 18 or inserted (at least partially) in the ground surface 18. In such an example, the second flange 30 (and/or the ground surface 18) may generate resistance that may prevent the ramp body 22 from moving further away from the vehicle 14 (e.g., moving right in FIG. 1) while the animal carcass is slid along the ramp body 22. Additional details regarding examples of the second flange 30 of the ramp 10 are discussed below with regard to FIGS. 2-4.

FIGS. 2A-2C illustrate various views of an example of the ramp of FIG. 1. For example, FIG. 2A illustrates a perspective view of the ramp 10, FIG. 2B illustrates a side view of the ramp 10, and FIG. 2C illustrates a front view of the ramp 10. As is illustrated, the ramp 10 includes the ramp body 22, the first flange 26, and the second flange 30. The ramp body 22 may include a top surface 34, a bottom surface 38, a first end 42, a second end 46, a first side 50, and a second side 54.

The top surface 34 may be the top-facing surface of the ramp body 22. As such, when an animal carcass is slid along the ramp body 22, the animal carcass may be in contact with and may slid along the top surface 34 of the ramp body 22. The bottom surface 38 may be the ground-facing surface of the ramp body 22. As such, when the ramp body 22 is positioned between the vehicle 14 and the ground surface 18 in order to load (and/or unload) the animal carcass, the bottom surface 38 may face the ground surface 18. The top surface 34 and the bottom surface 38 may be separated from each other by a thickness 58 of the ramp body 22. The thickness 58 may be any thickness. For example, the thickness 58 may be 0.25 inches, 0.33 inches, 0.5 inches, 1.0 inch, 1.5 inches, 2.0 inches, 2.5 inches, or any other amount of thickness. As another example, the thickness 58 may be approximately (i.e., +/−0.15 inches) 0.25 inches, approximately 0.33 inches, approximately 0.5 inches, approximately 1.0 inch, approximately 1.5 inches, approximately 2.0 inches, approximately 2.5 inches, or approximately any other amount of thickness. As a further example, the thickness 58 may be within a range of approximately 0.25 inches-approximately 2.5 inches, approximately 0.5 inches-approximately 2.5 inches, approximately 0.5 inches-approximately 1.5 inches, or any other range.

The first end 42 may be the vehicle-facing surface of the ramp body 22. As such, when the ramp body 22 is positioned between the vehicle 14 and the ground surface 18 in order to load (and/or unload) the animal carcass, the first end 42 may face the vehicle 14 (e.g., the first end 42 may face towards the left in FIG. 1). The second end 46 may be the back-facing surface of the ramp body 22. As such, when the ramp body 22 is positioned between the vehicle 14 and the ground surface 18 in order to load (and/or unload) the animal carcass, the second end 46 may face away from the vehicle 14 (e.g., the second end 46 may face towards the right in FIG. 1). The first end 42 and the second end 46 may be separated from each other by a length 62 of the ramp body 22. The length 62 may be any length. For example, the length 62 may be 4 feet, 5 feet, 6 feet, 7 feet, 8 feet, 9 feet, or any other amount of length. As another example, the length 62 may be approximately (i.e., +/−2 inches) 4 feet, approximately 5 feet, approximately 6 feet, approximately 7 feet, approximately 8 feet, approximately 9 feet, or approximately any other amount of length. As a further example, the length 62 may be within a range of approximately 4 feet-approximately 9 feet, approximately 6 feet-approximately 9 feet, approximately 6 feet-approximately 8 feet, or any other range.

The first side 50 may be a first side of the ramp body 22, and the second side 54 may be a second side of the ramp body 22. For example, as is illustrated in FIG. 2C, the first side 50 may define the left-most portion of the ramp body 22, and the second side 54 may define the right-most portion of the ramp body. As is discussed above, the ramp body 22 may be shaped to prevent an animal carcass (such as a deer carcass) from falling off the sides of the ramp body 22. In such an example, the ramp body 22 may be shaped to prevent the animal carcass from falling off first side 50 and/or second side 54.

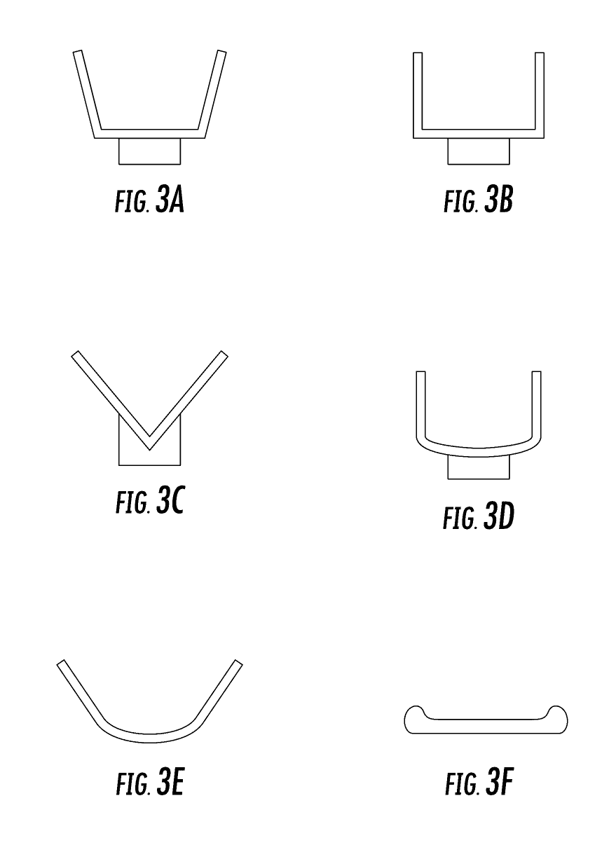

The ramp body 22 may be shaped in any manner to prevent the animal carcass from falling off the first side 50 and/or the second side 54 of the ramp body 22. For example, the ramp body 22 may be curved, as is illustrated in FIGS. 2A-2C. As another example, the ramp body 22 may be shaped to have a flat bottom portion connected to two straight and angled portions, as is illustrated in FIG. 3A. As a further example, the ramp body 22 may be shaped to have a flat bottom connected to two straight portions positioned at 90 degrees to the flat bottom, as is illustrated in FIG. 3B. As another example, the ramp body 22 may be shaped in the form of a “V”, as is illustrated in FIG. 3C. As a further example, the ramp body 22 may have a curved bottom connected to two straight portions positioned parallel to each other, as is illustrated in FIG. 3D. As another example, the ramp body 22 may have a curved bottom with two straight and angled portions, as is illustrated in FIG. 3E. As another example, the ramp body 22 may have one or more bumps (or bumpers) positioned at (or adjacent) the first side 50 and/or the second side 54, as is illustrated in FIG. 3F. As a further example, the ramp body 22 may have any other shape that may prevent the animal carcass from falling off the first side 50 and/or the second side 54 of the ramp body 22, or any combination of the shapes discussed above.

As illustrated in FIGS. 2A-2C, the ramp body 22 is curved. The ramp body 22 may have any type of curved shape that may prevent the animal carcass from falling off the first side 50 and/or the second side 54 of the ramp body 22. For example, the curve may have the shape of a segment (or portion) of a circle, a segment of an oval, a segment of any other curved shape, or any combination of the preceding. As illustrated in FIGS. 2A-2C, the curve of the ramp body 22 has the shape of a segment of a circle.

When the curve of the ramp body 22 has the shape of a segment (or portion) of a circle (or oval or any other curved shape), the circle may have any size. For example, the circle may have a radius 66 of 12 inches, 16 inches, 18 inches, 20 inches, 22 inches, 24 inches, 30 inches, 36 inches, or any other amount of a radius that may fit an animal carcass. As another example, the circle may have a radius 66 of approximately (+/−2 inches) 12 inches, approximately 16 inches, approximately 18 inches, approximately 20 inches, approximately 22 inches, approximately 24 inches, approximately 30 inches, approximately 36 inches, or approximately any other amount of a radius that may fit an animal carcass. As a further example, the circle may have a radius 66 within a range of approximately 12 inches-approximately 36 inches, approximately 18 inches-approximately 36 inches, approximately 18 inches-approximately 24 inches, or any other range that may fit an animal carcass. As illustrated in FIGS. 2A-2C, the curve of the ramp body 22 has the shape of a segment of a circle with a radius of approximately 18 inches.

Furthermore, when the curve of the ramp body 22 has the shape of a segment (or portion) of a circle (or oval or any other curved shape), the segment of the circle may be any portion of the circle. For example, the segment of the circle may have (or be defined by) an arc 70 between the first side 50 and the second side 54 of 90 degrees (quarter-circle), 100 degrees, 120 degrees, 150 degrees, 180 degrees (semi-circle), 210 degrees, or any other amount of an arc that may prevent the animal carcass from falling off the first side 50 and/or the second side 54 of the ramp body 22. As another example, the segment of the circle may have (or be defined by) an arc 70 of approximately (+/−10 degrees) 90 degrees, approximately 100 degrees, approximately 120 degrees, approximately 150 degrees, approximately 180 degrees, approximately 210 degrees, or approximately any other amount of an arc that may prevent the animal carcass from falling off the first side 50 and/or the second side 54 of the ramp body 22. As a further example, the segment of the circle may have (or be defined by) an arc 70 within a range of approximately 90 degrees-approximately 210 degrees, approximately 150 degrees-approximately 210 degrees, approximately 150 degrees-approximately 180 degrees, or any other range. As illustrated in FIGS. 2A-2C, the segment of the circle has (or is defined by) an arc 70 of approximately 180 degrees between the first side 50 and the second side 54.

The ramp body 22 may be made of (or otherwise constructed of) any material that may hold the weight of an animal carcass. For example, the ramp body 22 may be made of steel, stainless steel, aluminum, plastic, wood, fiberglass, any other material that may hold the weight of an animal carcass, or any combination of the preceding. The material of the ramp body 22 may further have a low coefficient of friction. This may make it easier to slide the animal carcass up (or down) the top surface 34 of the ramp body 22, for example. Furthermore, the top surface 34 of ramp body 22 may be coated with one or more materials (such as teflon) that may have a low coefficient of friction.

The ramp body 22 may be solid, or it may have one or more gaps or holes in it. For example, the top surface 34 and the bottom surface 38 may be solid surfaces. As another example, the top surface 34 and the bottom surface 38 may have one or more gaps or holes that may allow animal liquids and/or effluents to drain out of the ramp body 22 through the gaps or holes. As a further example, the top surface 34 and the bottom surface 38 may have one or more gaps or holes positioned adjacent to the first end 42 of the ramp body 22. These gaps or holes may allow a handle to be coupled to the ramp body 22 (e.g., a wooden handle coupled to the ramp body 22 by ropes through the gaps or holes), so as to allow the ramp body 22 to be more easily carried, moved around, and/or positioned between the vehicle 14 and the ground surface 18. Additionally, these gaps or holes may allow one or more securing devices (such as a chain or a lock) to be coupled to both the ramp body 22 and the vehicle 14, thereby further securing the ramp body 22 to the vehicle 14. As another example, the top surface 34 and the bottom surface 38 may have one or more gaps or holes positioned adjacent the second end 46 of the ramp body 22. These gaps or holes may allow one or more securing devices (such as a stake) to be inserted into the gaps or holes, and further inserted into the ground surface 18, thereby further securing the ramp body 22 to the ground surface 18.

As is further illustrated in FIGS. 2A-2C, the ramp 10 further includes the first flange 26 coupled to the bottom surface 38 of the ramp body 22. The first flange 26 may be any protrusion that may extend downward from the ramp body 22. For example, the first flange 26 may be a flange, a protrusion, an extension, a bump, a bar (such as a flat bar), any other protrusion that may extend downward from the ramp body 22, or any combination of the preceding. As illustrated, the first flange 26 is a flat bar. The first flange 26 may be positioned against a portion of the vehicle 14, such as the back of the bed of a truck or the tailgate of the bed of a truck. Furthermore, the first flange 26 may further prevent the ramp body 22 from moving further into the vehicle 14. For example, the first flange 26 may extend downward from the ramp body 22, thereby creating a ledge (or a stop) that may prevent the ramp body 22 from moving further into the vehicle (e.g., moving towards the left in FIG. 1) while the animal carcass is slid along the ramp body 22. Instead, the first flange 26 may hold the ramp body 22 in place against the portion of the vehicle 14.

The first flange 26 may have any shape. For example, the first flange 26 may be shaped as a rectangle, a square, a triangle, a circle, any other shape, or any combination of the preceding. As another example, the first flange 26 may be shaped as approximately a rectangle, approximately a square, approximately a triangle, approximately a circle, approximately any other shape, or any combination of the preceding. In such an example, the approximately may refer to the shape (e.g., a rectangle) plus or minus any other additional shape or material that may allow the first flange 26 to be coupled to the shape of the ramp body 22 (e.g., the curved shape of the ramp body 22). For example, as is illustrated in FIG. 2C, the first flange 26 may be approximately rectangle as a result of having a rectangle shape minus a curved section that allows the first flange 26 to be coupled to the curved shape of the ramp body 22. The first flange 26 may have a flat bottom 72, as is illustrated in FIGS. 2B-2C. Alternatively, the first flange 26 may have a pointed or rounded bottom 72.

The first flange 26 may have any size. For example, the first flange 26 may have a height 74 of 2 inches, 3 inches, 4 inches, 5 inches, 6 inches, 7 inches, approximately (+/−0.5 inches) 2 inches, approximately 3 inches, approximately 4 inches, approximately 5 inches, approximately 6 inches, approximately 7 inches, or any other amount of height. As another example, the first flange 26 may have a width 78 of 5 inches, 10 inches, 12 inches, 15 inches, 18 inches, 20 inches, 24 inches, 30 inches, 34 inches, 50 inches, approximately (+/−1 inch) 5 inches, approximately 10 inches, approximately 12 inches, approximately 15 inches, approximately 18 inches, approximately 20 inches, approximately 24 inches, approximately 30 inches, approximately 34 inches, approximately 50 inches, or any other amount of width. As a further example, the first flange 26 may have a thickness 82 of 1 inch, 2 inches, 3 inches, 5 inches, 6 inches, 7 inches, approximately (+/−0.5 inches) 1 inch, approximately 2 inches, approximately 3 inches, approximately 5 inches, approximately 6 inches, approximately 7 inches, or any other amount of thickness.

One or more (or all) of the height 74, width 78, and thickness 82 may vary along the first flange 26. As one example, the thickness 82 of the first flange 26 may decrease towards the bottom surface 72, thereby forming a “V” shape. In such an example, the first flange 26 may be hollow, and the hollow portion of the first flange 26 may be accessible through the top surface 34 of the ramp body 22. This may allow a ramp body 22 of a first ramp 10 to be stacked on top of a ramp body 22 of a second ramp 10 (e.g., for shipping of ramps 10), with the first flange 26 of the first ramp 10 being positioned within the hollow portion of the first flange 26 of the second ramp 10.

The first flange 26 may be positioned at any location on the length 62 of the ramp body 22. For example, the first flange 26 may be positioned at a location that is at the first end 42, 0.5 inches from the first end 42, 1 inch from the first end 42, 2 inches from the first end 42, 3 inches from the first end 42, 4 inches from the first end 42, 5 inches from the first end 42, 6 inches from the first end 42, 8 inches from the first end 42, 12 inches from the first end 42, 18 inches from the first end 42, or any other location on the length 62 of the ramp body 22. As another example, the first flange 26 may be positioned at location that is approximately (i.e., +/−0.25 inches) 0.5 inches from the first end 42, approximately 1 inch from the first end 42, approximately 2 inches from the first end 42, approximately 3 inches from the first end 42, approximately 4 inches from the first end 42, approximately 5 inches from the first end 42, approximately 6 inches from the first end 42, approximately 8 inches from the first end 42, approximately 12 inches from the first end 42, approximately 18 inches from the first end 42, or approximately any other location on the length 62 of the ramp body 22. As another example, the first flange 26 may be positioned at a location that within the range of approximately 0.5 inches from the first end 42-approximately 12 inches from the first end 42, approximately 2 inches from the first end 42-approximately 8 inches from the first end 42, approximately 2 inches from the first end 42-approximately 6 inches from the first end 42, or any other range.

This distance between the first end 42 and the location of the first flange 26 may allow a portion of the ramp body 22 to lay against (or on top) of the portion of the vehicle 14 (such as the bed of a truck or the tailgate of a truck), while the first flange 26 is positioned against the portion of the vehicle 14, for example. An example of this may be seen in FIG. 1. As such, the distance between the first end 42 and the location of the first flange 26 may provide additional stability to the ramp 10 while an animal carcass is slid along the top surface 34 of the ramp body 22, for example.

The first flange 26 may be coupled to the bottom surface 38 of the ramp body 22 at an angle 86 to the ramp body 22. The angle 86 may be any angle. For example, the angle 86 may be 20 degrees, 30 degrees, 45 degrees, 60 degrees, 80 degrees, 90 degree, 100 degrees, 110 degrees, 120 degrees, or any other angle. As another example, the angle 86 may be approximately (i.e., +/−10 degrees) 20 degrees, approximately 30 degrees, approximately 45 degrees, approximately 60 degrees, approximately 80 degrees, approximately 90 degree, approximately 100 degrees, approximately 110 degrees, approximately 120 degrees, or approximately any other angle. As a further example, the angle 86 may be within a range of approximately 20 degrees-approximately 110 degrees, approximately 50 degrees-approximately 110 degrees, approximately 80 degrees-approximately 110 degrees, or any other range.

The first flange 26 may be coupled to the bottom surface 38 of the ramp body 22 in any manner. For example, the first flange 26 may be coupled to the bottom surface 38 by welding, one or more screws, one or more nuts and bolts, one or more nails, one or more clips, any other means of coupling, or any combination of the preceding. As another example, the first flange 26 may be formed integral with the bottom surface 38 of the ramp body 22. The first flange 26 may be removably coupled to the bottom surface 38. In such an example, the first flange 26 may be coupled to the bottom surface 38 when the ramp 10 is used to move an animal carcass into the vehicle 14, and may be removed from the bottom surface 38 when the ramp 10 is being moved or shipped. The first flange 26 may be movably coupled to the bottom surface 38. For example, the first flange 26 may be coupled to the bottom surface 38 by a locking hinge. The hinge may allow the first flange 26 to be extended downward (and locked) at the angle 86 when the ramp 10 is used to move an animal carcass into a vehicle 14, and may further allow the first flange 26 to be folded forward or backward towards the bottom surface 38 when the ramp 10 is being moved or shipped.

The first flange 26 may be made of (or otherwise constructed of) any material that may hold the weight of an animal carcass. For example, the first flange 26 may be made of steel, stainless steel, aluminum, plastic, wood, fiberglass, any other material that may hold the weight of an animal carcass, or any combination of the preceding. The material of the first flange 26 may be the same as the material of the ramp body 22, or the materials may be different.

As is also illustrated in FIGS. 2A-2C, the ramp 10 further includes the second flange 30 coupled to the bottom surface 38 of the ramp body 22. The second flange 30 may be any protrusion that may extend downward from the ramp body 22. For example, the second flange 30 may be a flange, a protrusion, an extension, a bump, a bar (such as a flat bar), any other protrusion that may extend downward from the ramp body 22, or any combination of the preceding. As illustrated, the second flange 30 is a flat bar. The second flange 30 may be positioned against the ground surface 18. For example, the second flange 30 may be in contact with the top of the ground surface 18 or inserted (at least partially) into the ground surface 18. Furthermore, the second flange 30 may further prevent the ramp body 22 from tilting from side to side. For example, the second flange 30 may extend downward from the ramp body 22 and may be in contact with the top of the ground surface 18 or inserted (at least partially) in the ground surface 18. As such, the second flange 30 may provide stabilization of the ramp body 22 on (or in) the ground surface 18, which may prevent (or reduce the risk of) the shape of the ramp body 22 from causing the ramp body 22 to tilt from side to side as the animal carcass is slid (or otherwise moved) up the ramp body 22 into the vehicle 14. Additionally, the second flange 30 may further prevent the ramp body 22 from moving further away from the vehicle 14. For example, the second flange 30 may extend downward from the ramp body 22 and may be in contact with the top of the ground surface 18 or inserted (at least partially) in the ground surface 18. In such an example, the second flange 30 (and/or the ground surface 18) may generate resistance that may prevent the ramp body 22 from moving further away from the vehicle 14 (e.g., moving right in FIG. 1) while the animal carcass is slid along the ramp body 22.

The second flange 30 may have any shape. For example, the second flange 30 may be shaped as a rectangle, a square, a triangle, a circle, any other shape, or any combination of the preceding. As another example, the second flange 30 may be shaped as approximately a rectangle, approximately a square, approximately a triangle, approximately a circle, approximately any other shape, or any combination of the preceding. In such an example, the approximately may refer to the shape (e.g., a rectangle), plus or minus any other shape or material that may allow the second flange 30 to be coupled to the shape of the ramp body 22 (e.g., the curved shape of the ramp body 22), as is illustrated in FIG. 2C with regard to first flange 26. The second flange 30 may have a flat bottom 88, as is illustrated in FIGS. 2B-2C. Alternatively, the second flange 30 may have a pointed or rounded bottom 88. The pointed bottom may, for example, further enable the second flange 30 to be at least partially inserted into the ground, so as to generate additional stability and/or generate additional resistance to movement away from the vehicle 14. The second flange 30 may have the same shape as the first flange 26, or may have a different shape. As illustrated in FIGS. 2A-2C, the second flange 30 and the first flange 26 have the same shape.

The second flange 30 may have any size. For example, the second flange 30 may have a height 90 of 2 inches, 3 inches, 4 inches, 5 inches, 6 inches, 7 inches, approximately (+/−0.5 inches) 2 inches, approximately 3 inches, approximately 4 inches, approximately 5 inches, approximately 6 inches, approximately 7 inches, or any other amount of height. As another example, the second flange 30 may have a width (not illustrated) of 5 inches, 10 inches, 12 inches, 15 inches, 18 inches, 20 inches, 24 inches, 30 inches, 34 inches, 50 inches, approximately (+/−1.0 inches) 5 inches, approximately 10 inches, approximately 12 inches, approximately 15 inches, approximately 18 inches, approximately 20 inches, approximately 24 inches, approximately 30 inches, approximately 34 inches, approximately 50 inches, or any other amount of width. As a further example, the second flange 30 may have a thickness 94 of 1 inch, 2 inches, 3 inches, 5 inches, 6 inches, 7 inches, approximately (+/−0.5 inches) 1 inch, approximately 2 inches, approximately 3 inches, approximately 5 inches, approximately 6 inches, approximately 7 inches, or any other amount of thickness.

One or more (or all) of the height 90, width, and thickness 94 may vary along the second flange 30. As one example, the thickness 94 of the second flange 30 may decrease towards the bottom surface 88, thereby forming a “V” shape. In such an example, the second flange 30 may be hollow, and the hollow portion of the second flange 30 may be accessible through the top surface 34 of the ramp body 22. This may allow a ramp body 22 of a first ramp 10 to be stacked on top of a ramp body 22 of a second ramp 10 (e.g., for shipping of ramps 10), with the second flange 30 of the first ramp 10 being positioned within the hollow portion of the second flange 30 of the second ramp 10. The second flange 30 may have the same sizes as the first flange 26, or may have one or more different sizes than the first flange 26. As illustrated in FIGS. 2A-2C, the second flange 30 and the first flange 26 have the same sizes.

The second flange 30 may be positioned at any location on the length 62 of the ramp body 22. For example, the second flange 30 may be positioned at a location that is at the second end 46, 0.5 inches from the second end 46, 1 inch from the second end 46, 2 inches from the second end 46, 3 inches from the second end 46, 4 inches from the second end 46, 5 inches from the second end 46, 6 inches from the second end 46, 8 inches from the second end 46, 12 inches from the second end 46, 18 inches from the second end 46, or any other location on the length 62 of the ramp body 22. As another example, the second flange 30 may be positioned at location that is approximately (i.e., +/−0.25 inches) 0.5 inches from the second end 46, approximately 1 inch from the second end 46, approximately 2 inches from the second end 46, approximately 3 inches from the second end 46, approximately 4 inches from the second end 46, approximately 5 inches from the second end 46, approximately 6 inches from the second end 46, approximately 8 inches from the second end 46, approximately 12 inches from the second end 46, approximately 18 inches from the second end 46, or approximately any other location on the length 62 of the ramp body 22. As another example, the second flange 30 may be positioned at a location that is within the range of approximately 0.5 inches from the second end 46-approximately 12 inches from the second end 46, approximately 2 inches from the second end 46-approximately 8 inches from the second end 46, approximately 2 inches from the second end 46-approximately 6 inches from the second end 46, or any other range.

The second flange 30 may be positioned at the same distance from the second end 46 as the first flange 26 is positioned from the first end 42, or the second flange 30 may be positioned at a different distance from the second end 46 than the first flange 26 is positioned from the first end 42. As illustrated in FIGS. 2A-2C, the second flange 30 is positioned approximately 2 inches from the second end 46, while the first flange 26 is positioned approximately 4 inches from the first end 46.

The second flange 30 may be coupled to the bottom surface 38 of the ramp body 22 at an angle 98 to the ramp body 22. The angle 98 may be any angle. For example, the angle 98 may be 20 degrees, 30 degrees, 45 degrees, 60 degrees, 80 degrees, 90 degree, 100 degrees, 110 degrees, 120 degrees, or any other angle. As another example, the angle 98 may be approximately (i.e., +/−10 degrees) 20 degrees, approximately 30 degrees, approximately 45 degrees, approximately 60 degrees, approximately 80 degrees, approximately 90 degrees, approximately 100 degrees, approximately 110 degrees, approximately 120 degrees, or approximately any other angle. As a further example, the angle 98 may be within a range of approximately 20 degrees-approximately 110 degrees, approximately 50 degrees-approximately 110 degrees, approximately 80 degrees-approximately 110 degrees, or any other range.

The angle 98 of the second flange 30 may, for example, further enable the second flange 30 to be at least partially inserted into the ground, so as to generate additional stability and/or generate additional resistance to movement away from the vehicle 14. For example, the angle 98 (such as an angle less than or equal to approximately 90 degrees) may provide for easier insertion into the ground surface 18. The angle 98 of the second flange 30 may be the same angle as the angle 86 of the first flange 26, or may be a different angle. As illustrated in FIGS. 2A-2C, the angle 98 of the second flange 30 is the same angle as the angle 86 of the first flange 26

The second flange 30 may be coupled to the bottom surface 38 of the ramp body 22 in any manner. For example, the second flange 30 may be coupled to the bottom surface 38 by welding, one or more screws, one or more nuts and bolts, one or more nails, one or more clips, any other means of coupling, or any combination of the preceding. As another example, the second flange 30 may be formed integral with the bottom surface 38 of the ramp body 22. The second flange 30 may be removably coupled to the bottom surface 38. In such an example, the second flange 30 may be coupled to the bottom surface 38 when the ramp 10 is used to move an animal carcass into a vehicle 14, and may be removed from the bottom surface 38 when the ramp 10 is moved or shipped. The second flange 30 may be movably coupled to the bottom surface 38. For example, the second flange 30 may be coupled to the bottom surface 38 by a locking hinge. The hinge may allow the second flange 30 to be extended downward (and locked) at the angle 98 when the ramp 10 is used to move an animal carcass into a vehicle 14, and may further allow the second flange 30 to be folded forward or backward towards the bottom surface 38 when the ramp 10 is moved or shipped. The second flange 30 may be coupled to the bottom surface 38 in the same manner as the first flange 26, or in a different manner. As illustrated in FIGS. 2A-2C, the second flange 30 and the first flange 26 are coupled in the same manner.

The second flange 30 may be made of (or otherwise constructed of) any material that may hold the weight of an animal carcass. For example, the second flange 30 may be made of steel, stainless steel, aluminum, plastic, wood, fiberglass, any other material that may hold the weight of an animal carcass, or any combination of the preceding. The material of the second flange 30 may be the same as the material of the ramp body 22, or the materials may be different. Furthermore, the material of the second flange 30 may be the same as the material of the first flange 30, or the materials may be different. As illustrated in FIG. 2A-2C, the material of the ramp body 22, the first flange 26, and the second flange 30 is the same.

Modifications, additions, combinations, or omissions may be made to the ramp 10 of FIGS. 1-3 without departing from the scope of the disclosure. For example, although the ramp 10 has been described above as including both a first flange 26 and a second flange 30, in further examples, the ramp 10 may not include a first flange 26. Instead, the top surface 34 and bottom surface 38 may have one or more gaps or holes positioned adjacent the first end 42 of the ramp body 22. These gaps or holes may allow one or more securing devices (such as a chain or a lock) to be coupled to both the ramp body 22 and the vehicle 14, thereby securing the ramp body 22 to the vehicle 14.

As another example, although the ramp 10 has been described above as including both a first flange 26 and a second flange 30, in further examples, the ramp 10 may not include a second flange 30. Instead, the top surface 34 and bottom surface 38 may have one or more gaps or holes positioned adjacent the second end 46 of the ramp body 22. These gaps or holes may allow one or more securing devices (such as a stake) to be inserted into the gaps or holes, and further inserted into the ground surface 18, thereby securing the ramp body 22 to the ground surface 18. As a further example, although the first flange 26 and the second flange 30 has been described above as being coupled to the bottom surface 38 of the ramp body 22, in additional examples, the first flange 26 and/or the second flange 30 may be coupled to any other portion of the ramp body 22.

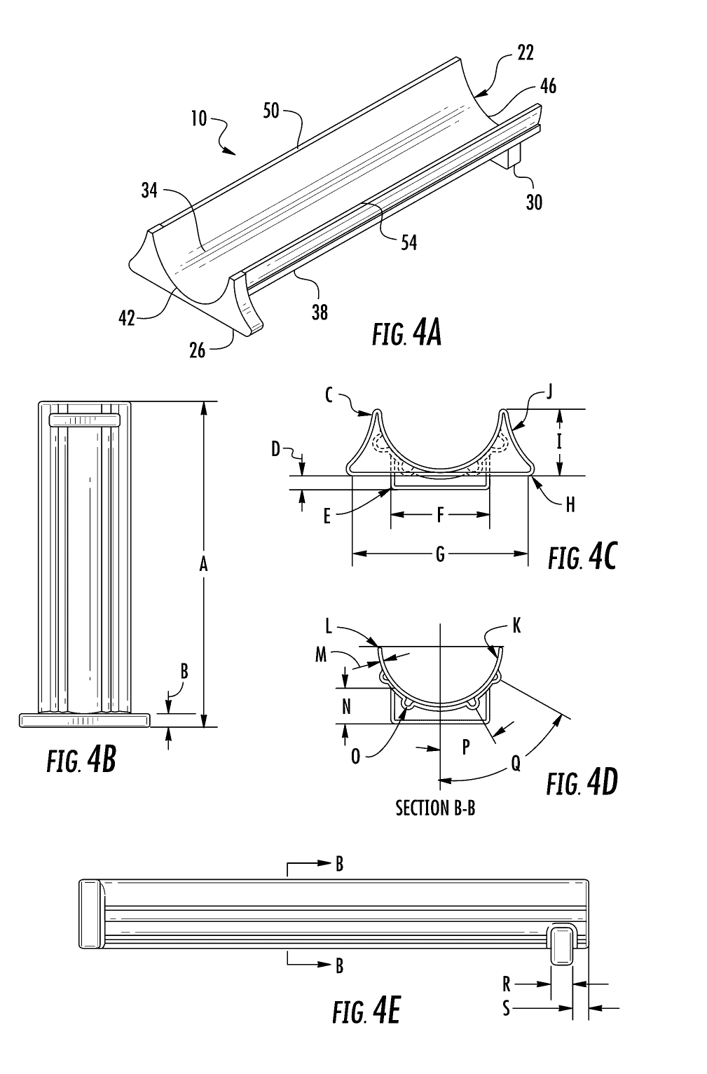

FIGS. 4A-4E illustrate various views of another example of the ramp 10 of FIG. 1.

As illustrated, the ramp 10 includes the ramp body 22. The ramp body 22 includes the top surface 34, the bottom surface 38, the first end 42, the second end 46, the first side 50, and the second side 54. Furthermore, the ramp 10 further includes the first flange 26 coupled to the bottom surface 38 of the ramp body 22, and further includes the second flange 30 coupled to the bottom surface 38 of the ramp body 22.

The ramp 10 of FIGS. 4A-4E may be similar to the ramp 10 of FIGS. 2A-2C. However, as is illustrated in FIGS. 4A-4E, the first flange 26 of the ramp 10 of FIGS. 4A-4E may further be a part of (or form) the first end 42 of the ramp 10. Additionally, the ramp 10 may have the following dimensions:

A=72 inches+/−5 inches

B=3 inches+/−0.5 inches

C=Ø of 18 inches+/−2 inches

D=2.1 inches+/−0.5 inches

E=radius of 0.5 inches+/−0.2 inches

F=15 inches+/−2 inches

G=26.28 inches+/−3 inches

H=radius of 1 inch+/−0.2 inches

I=10 inches+/−2 inches

J=radius of 15 inches+/−2 inches

K=0.1875 inch wall thickness+/−0.05 inches

L=Ø of 20 inches+/−3 inches

M=1 inch+/−0.5 inches

N=5.3 inches+/−0.5 inches

O=radius of 1 inch+/−0.2 inches

P=30 degrees+/−5 degrees

Q=60 degrees+/−10 degrees

R=3 inches+/−0.5 inches

S=2.5 inches+/−0.5 inches

Although the ramp 10 has been illustrated as including particular dimensions, the ramp 10 may have any other dimensions.

Modifications, additions, combinations, or omissions may be made to the ramp 10 of FIGS. 4A-4E without departing from the scope of the disclosure. For example, any of the elements, dimensions, shapes, and/or couplings of the ramp 10 of FIGS. 1-3 may be added to, combined with, or substituted for any of the elements, dimensions, shapes, and/or couplings of the ramp 10 of FIGS. 4A-4E.

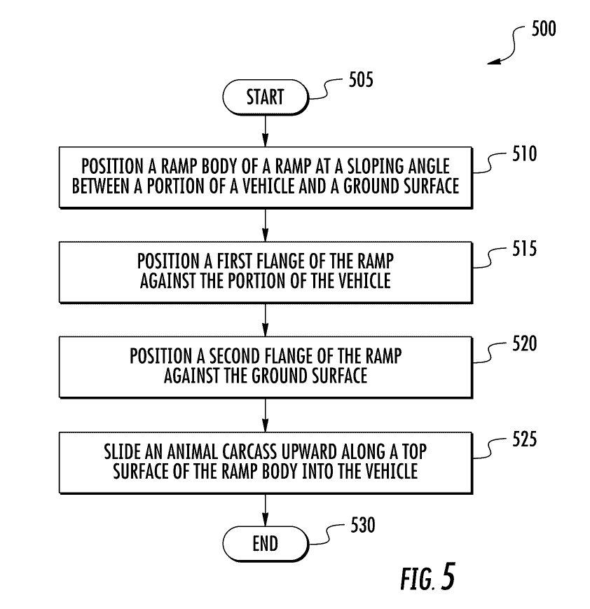

FIG. 5 illustrates an example method of using a ramp. One or more of the steps (such as all of the steps) of method 500 may be performed using any of the ramps 10 of FIGS. 1-4, or any other ramp. Furthermore, one or more of the steps (such as all of the steps) of method 500 may be performed by a manufacturer of a ramp, a seller of a ramp, a re-seller of a ramp, and/or a user of a ramp.

The method begins at step 505. At step 510, a ramp body 22 of a ramp 10 may be positioned at a sloping angle between a portion of a vehicle 14 and a ground surface 18. The ramp body 22 may be positioned at the sloping angle between the portion of the vehicle 14 and the ground surface 18 so as to allow an animal carcass to be slid upward along a top surface 34 of the ramp body 22 into the vehicle 14. The ramp body 22 may be positioned in any manner. As an example, a person may grip the ramp body 22 (and/or the front end 42 of the ramp body 42) and lift it upwards and towards the portion of the vehicle 14 (such as a bed of a truck or a tailgate of a truck). As another example, a person may grip a handle that is connected to the ramp body 22, and may use the handle to lift the ramp body 22 upwards and towards the portion of the vehicle 14. Furthermore, the person may also position the ramp body 22 against the portion of the vehicle 14 so as, for example, to hold the ramp body 22 at the sloping angle. The sloping angle may be any angle less than 90 degrees and greater than zero degrees, such as 60 degrees, 45 degrees, 40 degrees, 35 degrees, 30 degrees, or 25 degrees. In particular embodiments, the degree of the sloping angle may be based on a length 62 of the ramp body 22, the height of the vehicle 14, the height of the portion of the vehicle 14, and/or the position of the ground surface 18 (e.g., flat, inclined, irregular).

At step 515, a first flange 26 of the ramp 10 may be positioned against the portion of the vehicle 14. The first flange 26 of the ramp 10 may be positioned against the portion of the vehicle 14 so as to prevent the ramp body 22 from moving further into the vehicle 14 when the animal carcass is slid upward along the top surface 34 of the ramp body 22 into the vehicle 14. The first flange 26 may be positioned in any manner. As an example, a person may grip the ramp body 22 (and/or the front end 42 of the ramp body 42 and/or a handle coupled to the ramp body 22) and may pull the ramp body 22 towards the vehicle 14 until the first flange 26 contacts the portion of the vehicle 14. The ramp body 22 may be positioned at the sloping angle prior to positioning the first flange 26 against the portion of the vehicle 14, or the ramp body 22 may be positioned at the sloping angle at the same time as when the first flange 26 is positioned against the portion of the vehicle 14.

At step 520, a second flange 30 of the ramp 10 may be positioned against the ground surface 18. The second flange 30 of the ramp 10 may be positioned against the ground surface 18 so as to prevent the ramp body 22 from tilting from side to side when the animal carcass is slid upward along the top surface 34 of the ramp body 22 into the vehicle 14. The second flange 30 may be positioned against the ground surface 18 in any manner. As an example, a person may grip the ramp body 22 (and/or the second end 46 of the ramp body 42) and position the second flange 30 so it lays against (or on top of) the ground surface 18. As another example, the person may step on the ramp body 22 (or otherwise put pressure on the ramp body 22 and/or the second end 46 of the ramp body 22), causing the second flange 30 to be inserted at least partially into the ground surface 18. After performance of step 520, the installation of the ramp 10 may be complete. An example of a ramp 10 after a complete installation may be seen in FIG. 1.

At step 525, an animal carcass may be slid upward along the top surface 34 of the ramp body 22 into the vehicle 14. The animal carcass may be slid (or otherwise moved) upward along the top surface 34 of the ramp body 22 in any manner. For example, a winch (or pulley system) may be attached to the animal carcass and used to slide the animal carcass upward along the top surface 34 of the ramp body 22. As another example, a person may push or pull on the animal carcass (using their hands, ropes, and/or chains, for example) in order to slide the animal carcass upward along the top surface 34 of the ramp body 22. Once the animal carcass has been slid into the vehicle 14, the method 500 may end.

Modifications, additions, or omissions may be made to method 500. For example, although the method 500 has been described above with regard to an animal carcass, in additional examples, the method 500 (and/or the ramp 10) may be used to load any other item into the vehicle 14 (and/or unload any other item from the vehicle 14). For example, method 500 (and/or the ramp 10) may be used to load (and/or unload) sand bags, building materials, machinery, any other item, or any combination of the preceding.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification. In this manner, Applicant reserves the right to amend the claims during prosecution to add features as variously described in this specification.

What is claimed is:

1. A ramp for loading an animal carcass into a vehicle, comprising:
a ramp body having a top surface, a bottom surface, a first end, a second end, a first side, and a second side, the ramp body being curved, the curve of the ramp body having a shape of a segment of a circle with a radius of approximately 18 inches, the segment of the circle having an arc of approximately 180 degrees between the first side of the ramp body and the second side of the ramp body, the first end of the ramp body being separated from the second end of the ramp body by a length of the ramp body of approximately 6 feet, the ramp body being designed to be positioned at a sloping angle between a portion of the vehicle and a ground surface so as to allow an animal carcass to be slid upward along the top surface of the ramp body into the vehicle;
a first flange coupled to the bottom surface of the ramp body, the first flange being coupled to the bottom surface of the ramp body at an approximately 90 degree angle to the ramp body, the first flange being positioned along the length of the ramp body at a location that is approximately 4 inches from the first end of the ramp body, the first flange having a flat bottom, the first flange being designed to be positioned against the portion of the vehicle and further designed to prevent the ramp body from moving further into the vehicle; and
a second flange coupled to the bottom surface of the ramp body, the second flange being coupled to the bottom surface of the ramp body at an approximately 90 degree angle to the ramp body, the second flange being positioned along the length of the ramp body at a location that is approximately 2 inches from the second end of the ramp body, the second flange having a flat bottom, the second flange being designed to be positioned against the ground surface and further designed to prevent the ramp body from tilting from side to side.

2. A ramp for loading an animal carcass into a vehicle, comprising:
a ramp body having a top surface, a bottom surface, a first end, a second end, a first side, and a second side, the ramp body being curved, the first end of the ramp body being separated from the second end of the ramp body by a length of the ramp body, wherein the ramp body is designed to be positioned at a sloping angle between a portion of the vehicle and a ground surface so as to allow the animal carcass to be slid upward along the top surface of the ramp body into the vehicle;
a first flange coupled to the bottom surface of the ramp body, first flange being designed to be positioned against the portion of the vehicle; and
a second flange coupled to the bottom surface of the ramp body, the second flange being designed to be positioned against the ground surface.

3. The ramp of claim 2, wherein first flange is further designed to prevent the ramp body from moving further into the vehicle.

4. The ramp of claim 2, wherein the second flange is further designed to prevent the ramp body from tilting from side to side.

5. The ramp of claim 2, wherein the curve of the ramp body is designed to prevent the animal carcass from moving off the first side of the ramp body and the second side of the ramp body.

6. The ramp of claim 2, wherein the curve of the ramp body has a shape of a segment of a circle, wherein the segment of the circle has an arc between the first side of the ramp body and the second side of the ramp body, wherein the arc is approximately 180 degrees.

7. The ramp of claim 2, wherein the curve of the ramp body has a shape of a segment of a circle, wherein the segment of the circle has an arc between the first side of the ramp body and the second side of the ramp body, wherein the arc is between approximately 90 degrees and approximately 210 degrees.

8. The ramp of claim 2, wherein the length of the ramp body is approximately 6 feet.

9. The ramp of claim 2, wherein the length of the ramp body is between approximately 4 feet and approximately 9 feet.

10. The ramp of claim 2, wherein the ramp body is made of at least one of:
steel;
aluminum;
plastic;
wood; and
fiberglass.

11. The ramp of claim 2, wherein the curve of the ramp body has a shape of a segment of a circle with a radius of approximately 18 inches.

12. The ramp of claim 2, wherein the curve of the ramp body has a shape of a segment of a circle with a radius of between approximately 12 inches and approximately 36 inches.

13. The ramp of claim 2, wherein the second flange is coupled to the bottom surface at an angle of approximately 90 degrees to the ramp body.

14. The ramp of claim 2, wherein the second flange is coupled to the bottom surface at an angle of between approximately 20 degrees and approximately 110 degrees to the ramp body.

15. The ramp of claim 2, wherein the first flange is positioned along the length of the ramp body at a location that is approximately 4 inches from the first end of the ramp body, and the second flange is positioned along the length of the ramp body at a location that is approximately 2 inches from the second end of the ramp body.

16. The ramp of claim 2, wherein the first flange and the second flange are welded to the bottom surface of the ramp body.

17. The ramp of claim 2, wherein the first flange and the second flange are formed integral with the bottom surface of the ramp body.

18. The ramp of claim 2, wherein the animal carcass is selected from a group consisting of:
a deer carcass;
a hog carcass;
a boar carcass; and
an elk carcass.

19. A method, comprising:
positioning a ramp body of a ramp at a sloping angle between a portion of a vehicle and a ground surface so as to allow an animal carcass to be slid upward along a top surface of the ramp body into a vehicle, the ramp body having the top surface, a bottom surface, a first end, a second end, a first side, and a second side, the ramp body being curved, the first end of the ramp body being separated from the second end of the ramp body by a length of the ramp body;
positioning a first flange of the ramp against the portion of the vehicle so as to prevent the ramp body from moving further into the vehicle, the first flange being coupled to the bottom surface of the ramp body; and
positioning a second flange of the ramp against the ground surface so as to prevent the ramp body from tilting from side to side, the second flange being coupled to the bottom surface of the ramp body.

20. The method of claim 19, further comprising sliding the animal carcass upward along the top surface of the ramp body into the vehicle.
